(19) United States
(12) Patent Application Publication
(10) Pub. No.: US 2026/0148122 A1
(43) Pub. Date: May 28, 2026

(54) Rules Based Override of Machine Learning Output

(71) Applicant: eBay Inc., San Jose, CA (US)

(72) Inventors: Manohar Ellanti, Fremont, CA (US); Ayswarya Ravichandran, Newark, CA (US)

(73) Assignee: eBay Inc., San Jose, CA (US)

(21) Appl. No.: 18/957,306

(22) Filed: Nov. 22, 2024

(51) Int. Cl. G06N 20/00

(52) U.S. Cl. CPC G06N 20/00

(57) ABSTRACT

Rules based override of machine learning output is described. In one or more implementations, the described architecture receives a listing for an item having one or more attributes describing the item. A category of the item, as output by a machine learning model based on the listing, is also received. The machine learning model is trained using a dataset of listings labeled with item categories. A set of deterministic rules is executed on the one or more attributes describing the item and the output of the machine learning model, including identifying the category of the item and applying one or more of the deterministic rules associated with the category. Based on the executing, a different category of the item is output and overrides the category of the item as output by the machine learning model.

### BACKGROUND

The output of machine learning models is not always accurate. These models learn to make predictions based on patterns observed in their training datasets. However, if these datasets are biased, incomplete, or unrepresentative of a broader real-world context, the model's predictions may be skewed or incorrect. Furthermore, overfitting a model to the noise rather than the signal in the training data can degrade a model's performance on new, unseen data, and/or on fringe cases. Such inaccuracies can be particularly problematic in critical domains like financial service, healthcare, and law enforcement, where an incorrect prediction can have consequences that impact the lives and safety of people.

### SUMMARY

Rules based override of machine learning output is leveraged with an online marketplace. In one or more implementations, the described architecture combines machine learning with deterministic rules to enhance categorization accuracy, particularly for items that may be misclassified when using machine learning models alone. By way of example, the described system receives a listing for an item having attributes describing the item. A category of the item that is output by a machine learning model based on the listing is also received, where the machine learning model is trained using a dataset of listings labeled with item categories. A set of deterministic rules is executed on the attributes describing the item and the output of the machine learning model. This can include identifying the category of the item and applying one or more of the deterministic rules associated with the category, e.g., selected from a library of rules based on the category. Based on the executing, a different category of the item is output and overrides the category of the item output by the machine learning model. This approach allows for dynamic category adjustment without retraining the machine learning model, which can enable more precise categorization for tax code assignment and marketplace organization.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a user interface displayed in a scenario where rules based override of machine learning output is utilized.

FIG. 3 depicts another example of a user interface displayed in a scenario where rules based override of machine learning output is utilized.

FIG. 4 depicts another example of a user interface displayed in a scenario where rules based override of machine learning output is utilized.

FIG. 5 depicts a procedure in an example implementation of rules based override of machine learning output.

FIG. 6 illustrates an example of a system that may implement the various techniques described herein.

### DETAILED DESCRIPTION

### Overview

Machine learning models have revolutionized many fields due to their ability to process vast amounts of data and make predictions, often based on patterns in data that may not be readily recognizable by humans. However, these models are not infallible. They can produce inaccurate or biased results, especially when trained on datasets that are incomplete or that are updated as real-world scenarios unfold, e.g., as governments pass or change laws, as scientific discoveries are made, as entities change rules or policies, as technology (e.g., automotive) progresses, and so on. This limitation can be particularly problematic in critical domains where incorrect predictions may have impactful consequences.

To address these issues, rules based override of machine learning output is leveraged. The described system combines the advantages of machine learning with the precision of deterministic rules. In one or more implementations, the described techniques involve a two-step process for categorizing items, such as in the context of online marketplaces. First, a machine learning model, trained on a dataset of labeled listings, generates an initial category prediction for an item based on its attributes. Then, a set of deterministic rules is applied to potentially override this initial prediction.

In at least one implementation for an online marketplace, a listing for an item on the online marketplace is received. The listing includes various attributes describing the item, examples of which include a title of the listing, description, price, videos and/or images, and a user-selected category for the item, just to name a few. The machine learning model, previously trained on the dataset of listings labeled with item categories, processes at least some of this information to output a category prediction for this item. However, instead of accepting this prediction outright, the system then executes a set of deterministic rules.

These rules are applied to both the attributes of the item and the category output by the machine learning model. Based on the execution of these rules, the system may output a different category for the item, effectively overriding the initial machine learning prediction. One key feature of the described approach is its flexibility. The set of deterministic rules can be modified by user input without the need to retrain the machine learning model. This allows for quick adjustments to the categorization system, which can be particularly useful in dynamic environments where new categories or classification criteria may emerge rapidly—or at least more often than is desirable to retrain the machine learning model.

This approach can also handle scenarios where the different category output by the rules-based system is not present in the original training dataset of the machine learning model, but is added through the new rules. This capability allows the system to adapt to new categories or classification needs without requiring a complete overhaul of the machine learning model.

The system also takes into account practical considerations, such as tax implications. In some implementations, different categories may be associated with different tax codes. By allowing for precise category overrides, the system ensures that items are correctly classified for tax purposes, potentially avoiding costly errors and undesirable legal issues.

This approach offers several advantages over conventional machine learning-only systems. For instance, the described architecture combines the broad pattern recognition capabilities of machine learning with the precision and adaptability of rule-based systems. This hybrid approach can produce more accurate and reliable categorizations, especially in edge cases or scenarios not well-represented in the training data. Moreover, the ability to quickly modify rules without retraining the entire model saves computational resources and allows for rapid adaptation to changing requirements. This can be particularly valuable in fast-paced environments where categories and classification criteria may evolve quickly.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

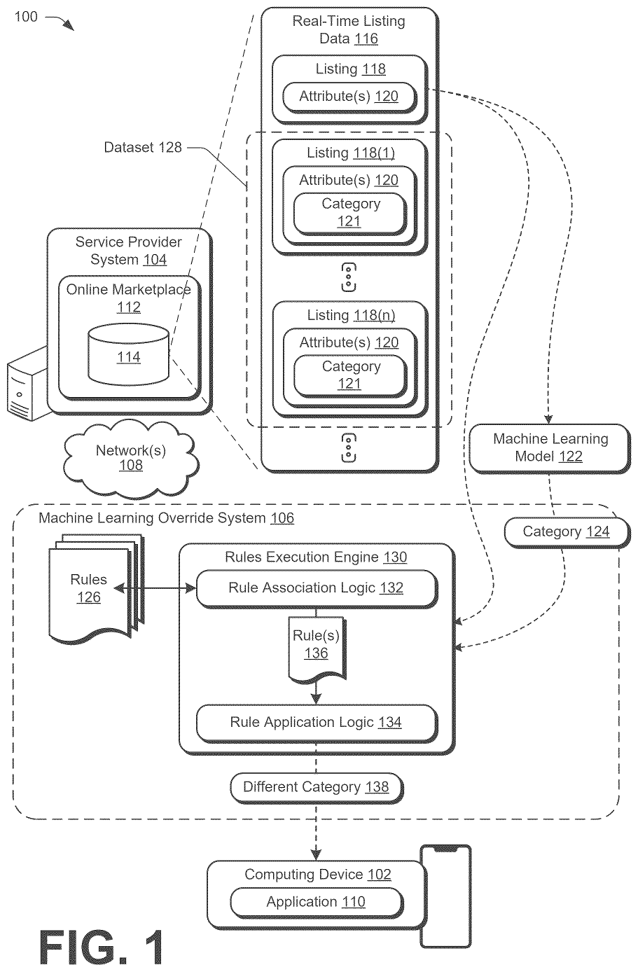

FIG. 1 is an illustration of an environment 100 in an example implementation that is operable to employ techniques described herein. The environment 100 includes a computing device 102, a service provider system 104, and a machine learning override system 106. In one or more implementations, the computing device 102, the service provider system 104, and the machine learning override system 106 are communicatively coupled, one to another, via network(s) 108. One example of the network(s) 108 is the Internet, although one or more of the computing device 102, the service provider system 104, and the machine learning override system 106 may be communicatively coupled using one or more different connections or different networks in various implementations.

Although the machine learning override system 106 is depicted in the environment 100 as being separate from the computing device 102 and the service provider system 104, in one or more implementations, an entirety or various portions of the machine learning override system 106 are implemented at or by the computing device 102 and/or the service provider system 104. In at least one implementation, for example, at least a portion of the machine learning override system 106 is implemented by an application 110 of the computing device 102 and/or using various resources of the computing device 102, such as hardware resources, an operating system, firmware, and so forth. Alternatively or additionally, at least a portion of the machine learning override system 106 is implemented by resources (e.g., server-based storage, processing, and so on) of the service provider system 104. Alternatively or additionally, at least a portion of the machine learning override system 106 is implemented using a third-party service, such as a web services platform that provides one or more hardware and/or other computing resources to support provision of services by web service providers.

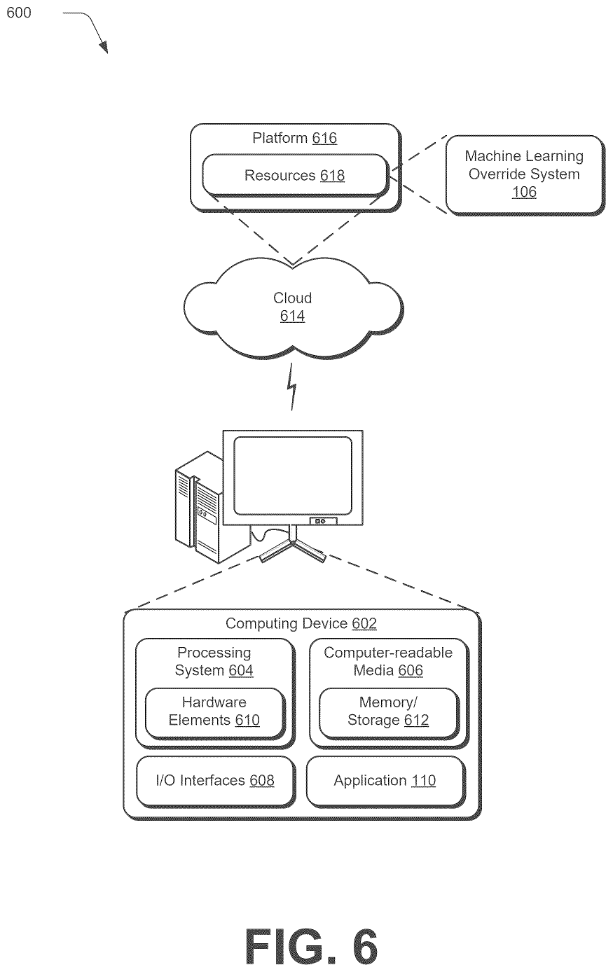

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 6.

In at least one implementation, the application 110 supports communication of data across the network(s) 108, such as between the computing device 102 and the service provider system 104 and/or between the computing device 102 and the machine learning override system 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112's website. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings for items and to expose those listings (e.g., publish them) across the network(s) 108 to one or more computing devices, including to the computing device 102. For example, the online marketplace 112 may generate listings for items for sale and expose those listings to computing devices, such that users of the computing devices can interact with the listings via user interfaces to initiate transactions (e.g., purchases, add to wish lists, share, and so on) in relation to the respective item or items of the listings. In accordance with the described techniques, the online marketplace 112 is configured to generate listings for one or more types of physical goods or property (e.g., clothing and/or clothing accessories, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 includes storage device 114, which is depicted maintaining real-time listing data 116. The real-time listing data 116 includes listings of the online marketplace 112, one example of which is listing 118. Other examples of such listings include listing 118(1) and listing 118(n), where ‘n’ represents any integer number greater than or equal to 2. The real-time listing data 116 is depicted with ellipses to indicate the existence of more listings than the listing 118, the listing 118(1), and the listing 118(n).

The storage device 114 may represent one or more databases and/or other types of storage capable of storing the real-time listing data 116. Examples of the storage device 114 include, but are not limited to, mass storage and virtual storage. In one or more implementations, for example, the storage device 114 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account.

In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items listed with the online marketplace 112 (e.g., the items that those users decide to list through the online marketplace 112) than the company associated with the online marketplace 112 (or its employees or agents).

Users that cause items to be listed on the online marketplace 112 may be referred to as “sellers,” whereas users that purchase or otherwise obtain items listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items to be listed on the online marketplace 112 and by interacting with the user interfaces to purchase one or more items from the listings of the online marketplace 112.

A user that is a seller, for instance, may interact with one or more user interfaces of the online marketplace 112 (e.g., output via the application 110) to provide information about one or more items which the user is causing to be listed on the online marketplace 112. Such user interfaces may include prompts that instruct, or guide, users that are sellers to provide various information about items being listed. Examples of information that such interfaces prompt sellers for and that those users provide include but are not limited a title, description (of the item), one or more prices (e.g., to purchase the item now and/or a minimum starting bid for the item), brand information, size, year, color(s), shipping information (e.g., cost and/or types available), delivery information, return information, payment information, images, videos, models, authenticity information, item history (e.g., chain of custody), and condition (of the item), to name a few.

One or more portions of such information may be referred to herein as “attributes” of the listing. For example, a title of the listing may be an attribute of the listing, a description of the item being listed may be an attribute of the listing, one or more images uploaded or selected for the listing may be one or more attributes of the listing, color(s) of the item may be an attribute of the listing, a category of the item may be an attribute of the listing, and so forth.

In one or more implementations, the online marketplace 112 saves and maintains the input information for a listing in the storage device 114 in fields of a data structure or data record populated for the listing, where a given field and the information populated and maintained for the given field correspond to a particular attribute of the listing. For instance, a ‘title’ field of such a data structure or data record may be populated with information (e.g., text) input into a user interface by a seller of a listing. The title field and the information input by the user as the title of the listing correspond to an attribute of the listing, e.g., a title attribute. In one or more implementations, one or more of the attributes of a listing may be derived and then populated by the online marketplace 112, such as by the online marketplace 112 processing one or more portions of the information input by a user to populate one or more respective attributes of the listing.

In at least one variation, for instance, the online marketplace 112 may process the input information and/or already populated attributes using artificial intelligence (e.g., generative artificial intelligence) to output information (e.g., a prediction) for populating at least one other attribute of the listing. As an example, the online marketplace 112 may use artificial intelligence to generate a title of the listing from the information input for the listing and/or listing attributes. The online marketplace 112 may automatically populate the title attribute with the generated title, or the online marketplace 112 may suggest such a title to the user, which the user can accept or decline. It is to be appreciated that a title attribute is merely an example, and the online marketplace 112 may derive and populate (or suggest populating) any of a variety of attributes for a listing.

In the context of the illustrated example, the listing 118 includes attribute(s) 120, the listing 118(1) includes attribute(s) 120(1), and the listing 118(n) includes attribute(s) 120(1). As noted above, those attributes represent any of a variety of information input or otherwise derived for the respective listings, such as a title, description (of the item), one or more prices (e.g., to purchase the item or for bidding on the item), brand information, size, year, color(s), shipping information (e.g., cost and/or types available), delivery information, return information, payment information, images, videos, models, authenticity information, item history (e.g., chain of custody), and condition (of the item), to name a few.

In addition to any one or more of those attributes, each of the listings of the online marketplace 112 is also associated with a ‘category’ attribute—at least one category attribute. As used herein, the term “category” refers a grouping of related items on the online marketplace 112. The use of categories is designed to help users (e.g., buyers) easily navigate and find items that share similar attributes or purposes. Categories are typically organized in a hierarchy, allowing users to explore broad item types (e.g., “Electronics”) and then drill down into more specific subcategories (e.g., “Mobile Phones,” “Laptops”, etc.). By organizing items into categories, the online marketplace 112 enhances user experience, simplifies search, and improves the efficiency of browsing and filtering options.

Additionally or alternatively, a category is useable for other purposes, such as to associate accurate tax rules or codes with an item of a listing. By way of example, in at least one location, a toy mattress (e.g., for a doll or dollhouse) may be subject to different taxes than a non-toy mattress (e.g., a mattress intended for an actual human to sleep on). Such tax codes are then used at the time of purchase along with location information of a buyer and/or the seller to compute and apply taxes for the purchase.

In operation, a particular category may have one or more subcategories, e.g., lower on a categorical hierarchy, that are applicable for various purposes and not for others, such as for taxes. Consider an example in which a pair of work boots is categorized as “shoes” for the purpose of navigation and searching. Suppose, however, that work boots fall into a different tax category than dress boots or snow boots. To apply the proper taxes for a purchase of work boots, the appropriate category needs to be determined and associated with the work boots at some point.

As a non-marketplace example, consider that a person is diagnosed with cancer using some computerized technique, such as by using a machine learning technique to predict the presence of cancer from one or more digital images produced by scanning a person with one or more sensors. A prediction or diagnosis of cancer may be sufficient for some purposes, like determining a ward or hospital wing where the patient can be admitted and/or for determining what group of doctors should next examine and/or care for the person. However, it is vastly insufficient for other purposes, like determining a course of treatment. In that case, further attributes may need to be considered to refine the initial prediction, or even override the initial prediction.

Returning now to the discussion of categories associated with the online marketplace 112. In one or more implementations, the one or more user interfaces, presented to a seller as part of collecting information for generating a listing, include one or more interactive elements which enable the user to provide a category for an item being listed, e.g., a hierarchy of the categories for selection, a dropdown of categories, a field (e.g., a text field) for typing categories, or for beginning to type categories which are then suggested as selectable tags, to name a few. Thus, user input attributes for the listing 118 may include a user input, or otherwise selected, category for the listing 118. As discussed above and below, the user-input category may be used, along with other information (e.g., other attributes of the listing 118), as a basis (or one piece of information) for assigning a category to the listing 118.

In accordance with the described techniques, machine learning model 122 is used to output a prediction (e.g., of a category 124 for the listing 118), and the output prediction is then processed by the machine learning override system 106, which determines whether to override the machine learning model 112's output prediction by applying a set of deterministic rules 126.

In the context of the online marketplace 112, for instance, the machine learning model 122 is configured to receive information about the listing 118 as input, such as one or more attribute(s) 120 of the listing 118, which can include a user-selected category for the item listed by the listing 118. Based on the information received as input, the machine learning model 122 is configured to output a prediction of a category 124 for the listing 118.

In one or more implementations, the machine learning model 122 is trained at least in part using a dataset 128 that includes listings selected from the real-time listing data 116, such as multiple listings 118(1)-118(n). Notably, the listings in the dataset 128 are already labeled with categories 121. The training process can thus involve utilizing the machine learning model 122 to predict categories for those listings based on their respective attributes 120 and then comparing the output predictions during training to the categories 121 with which the listings are already labeled. Internal weights of the machine learning model 122 may be adjusted based on one or more known machine learning training algorithms and responsive to the comparison of the machine learning model 122's output during training to the actual categories 121 of the respective listings. A difference between the actual category 121 and the predicted category may be determined based on one or more cost or loss functions.

In one or more implementations, the machine learning model 122 may be trained using the dataset 128 through a process of supervised learning. The dataset 128 may include a large number of listings from the real-time listing data 116, each associated with known categories 121. These listings and their corresponding categories serve as labeled training examples for the machine learning model 122.

During the training process, the machine learning model 122 may be presented with the attributes 120 of each listing in the dataset 128 as input. The model may then attempt to predict the category for each listing based on these attributes. The predicted category may be compared to the actual category 121 associated with the listing.

Based on this comparison, the model's internal parameters or weights may be adjusted to minimize the difference between the predicted and actual categories. This adjustment process may be repeated iteratively over many training examples, allowing the model to learn patterns and relationships between listing attributes and categories. In some cases, the training process may involve techniques such as cross-validation or regularization to improve the model's generalization ability and prevent overfitting to the training data. In some implementations, various training algorithms and loss/cost functions may be employed during the training process of the machine learning model 122. For instance, gradient descent-based optimization algorithms such as stochastic gradient descent (SGD), mini-batch gradient descent, or Adam (Adaptive Moment Estimation) may be utilized to adjust the model's parameters. These algorithms iteratively update the model's weights to minimize the chosen loss function.

Broadly, machine learning models excel at identifying complex patterns in data and outputting predictions accurately for a certain level of granularity. A trained machine learning model can also process varied input information faster than hard-coded rules to make and output a prediction. However, the output of such machine learning models may not be accurate enough at finer granularities for niche areas, outliers, and highly sensitive applications where correctness is paramount, e.g., tax categorization, adverse health outcome diagnoses (e.g., disease diagnosis), automated driving, and so forth. For example, the predictions of a given machine learning model may be 80% accurate. This level of accuracy may be suitable some scenarios, such as determining where a listing can be categorized for site navigation purposes in the online marketplace 112. For purposes such as categorizing a listed item for tax purposes or predicting whether a person's digital health information indicates a diagnosis of cancer (or a particular type of cancer), though, 80% accuracy is not suitable.

By applying the set of deterministic rules 126 to the output of the machine learning model 122, the machine learning override system 106 improves on the accuracy of the machine learning model 122's output, while also exploiting the model's speed of prediction and ability to identify relevant signals within potentially complex input data (e.g., the attribute(s) 120) and/or where relevant signals would not be obvious to at least some humans. The model's speed and ability to identify relevant signals, which are acquired through one or more training processes, are thus still exploited by the described systems to output a coarse prediction of a category, e.g., within 80% accuracy. Broadly, those training processes may involve processing massive amounts of training data with the machine learning model 122 and iteratively adjusting the model (e.g., internal weights) based on the training output received from the model and one or more training algorithms.

In the illustrated example, the machine learning override system 106 includes a rules execution engine 130, which is depicted having rule association logic 132 and rule application logic 134. In at least one implementation, the rules execution engine 130 is executable program code (e.g., one or more executables or “binaries”) executed by one or more processors of a computing system, such as by one or more processors of a server of the online marketplace 112 and/or by one or more processors of the computing device 102. Accordingly, the rule association logic 132 and the rule application logic 134 may be “modules” (or portions) of the program code executed by the processors to implement the rules execution engine 130 and the program code, when executed by the processors, causes specific operations of the rules execution engine 130 to be performed.

In one or more implementations, for instance, the rule association logic 132 is configured to, from the set of deterministic rules 126, associate (or otherwise select) one or more rules with the category 124, as output by the machine learning model 122. The associated or otherwise selected one or more rules may be referred to herein as selected rule(s) 136, and the selected rule(s) 136 may be a subset selected from a library of the deterministic rules 126. The rule application logic 134 is configured to apply the selected rule(s) 136 to the category 124. In at least some scenarios, application of the selected rule(s) 136 by the rule application logic 134 results in the rules execution engine 130 confirming the category 124 output by the machine learning model 122 for the listing 118. In other scenarios, however, application of the selected rule(s) 136 by the rule application logic 134 causes the rules execution engine 130 to override the category 124 output by the machine learning model 122. In such scenarios, the rules execution engine 130 may identify and output a different category 138 for the listing 118 based on application of the selected rule(s) 136.

Based on identification of the different category 138, the different category 138 is associated with the listing 118, such as by the machine learning override system 106 and/or the online marketplace 112. To associate the different category 138 with the listing 118, the machine learning override system 106 and/or the online marketplace 112 may add the different category 138 to the attribute(s) 120 of the listing 118 as an additional attribute, such that the attribute(s) 120 of the listing include both the category 124 as output by the machine learning model 122 and also include the different category 138 as identified by the rules execution engine 130. Alternatively, the different category 138 may replace the category 124 in the attribute(s) 120 of the listing 118, e.g., in a ‘category’ attribute.

In one or more implementations, the rule association logic 132 is run to select a subset of rules from the library of deterministic rules 126 based on one or more of: the category 124 as output by the machine learning model 122, a category as selected by a user associated with the listing (e.g., a seller for the listing), and/or one or more other attribute(s) 120 of the listing 118. In other words, the category 124 as output by the machine learning model 122, a category as selected by a user associated with the listing (e.g., a seller for the listing), and/or one or more other attribute(s) 120 of the listing 118, may serve as input to the rule association logic 132. Other example inputs to the rule association logic 132 may include, for instance, a confidence score output by the machine learning model 122 in connection with the set of deterministic rules 126, a probability of the category 124 as output by the machine learning model 122, probabilities of other categories as output by the machine learning model 122 (e.g., second most likely category based on probability, kth most likely category based on probability), a top k categories, and/or a location of a user associated with the listing 118 (e.g., buyer and/or seller), to name just a few. In one or more implementations, the machine learning override system 106 executes the set of deterministic rules 126 based on a confidence score output by the machine learning model 122 in connection with the output of the machine learning model 122 (e.g., the category 124) failing to satisfy a confidence threshold. Alternatively or additionally, the machine learning override system 106 executes the set of deterministic rules 126 based on a probability associated with the output (e.g., the category 124) of the machine learning model 122 failing to satisfy a threshold value.

The rule association logic 132 may be configured to receive as input any of a variety of information that is relevant to selecting which rules should be applied to determine an accurate category for the listing 118. Based on receiving the input information, the rule association logic 132 outputs or otherwise indicates at least a subset of the deterministic rules 126 (e.g., the selected rule(s) 136) for application to the listing 118 and/or the category 124. In one example, for instance, if the category 124 and/or the attribute(s) 120 of the listing 118 indicate that the item being listed via the listing 118 is a shoe, then the rule association logic 132 can select one or more rules of the set of deterministic rules 126 that are applicable to shoes (e.g., all of the rules that are applicable to shoes).

The rule application logic 134 is run to apply the selected rule(s) 136 to the listing 118 and/or to the category 124. By way of example, the selected rule(s) 136 may specify one or more criteria, which the rule application logic 134 applies to confirm the category 124 or to identify and output a different category 138 for the listing 118.

By way of example, the deterministic rules 126, and thus the selected rule(s) 136, may comprise conditional statements (e.g., if-then statements). When the rule application logic 134 applies such statements, for instance, if one or more specified attribute(s) 120 are present or absent and/or such attributes include or do not include particular information (depending on what is specified by the particular rule), then the rule application logic 134 deterministically associates a category specified in the rule with the listing 118. In one example, a rule may specify that if a particular attribute is present or if the particular attribute includes certain information defined by the rule, then a category specified in the rule is to be associated with the listing 118. Alternatively or in addition, a rule may be location based such that in one location a category to associate with an item is different from the category to associate with the item in a different location.

In some instances, a category specified by a rule for a listing may be the same as the category 124 output by the machine learning model 122, such that the machine learning override system 106 confirms the machine learning model 122. In other instances, however, the category specified by a rule for a listing may be the different category 138. The rules in the set of deterministic rules 126 may have any of a variety of different deterministic formats in accordance with the described techniques, which the rule application logic 134 is capable of applying to the listing 118 and its information (e.g., to the attribute(s) 120) to identify a category for the listing 118.

Due to the deterministic nature of the set of deterministic rules 126, there may be a higher confidence in a category identified for a listing based on application of the set of deterministic rules 126 than a category predicted by the machine learning model 122. Moreover, additional rules (e.g., new rules) may be added to the set of deterministic rules 126 at relatively low cost. For example, adding a rule to the set of deterministic rules 126 may simply involve adding an additional conditional statement, e.g., an additional if-then statement. When information is present in a listing 118 or in a category output by the machine learning model 122 for selecting a new rule, the rule association logic 132 is capable of selecting the new rule from the set of deterministic rules 126 and causing the rule application logic 134 to use the new rule as one of the selected rule(s) 136.

By way of contrast, updating the machine learning model 122 to recognize and apply such a new rule can consume significant computing resources. To do so, for instance, suitable training data with positive examples of the new rule has to be compiled. The machine learning model 122 then has to be retrained not only with the new training data, but also with previous training data to maintain the ability to predict other categories which the machine learning model 122 was already capable of predicting for the variety of listings maintained by the online marketplace 112. In some cases, the amount of training data (e.g., the dataset 128) is vast, such that retraining the machine learning model 122 to output suitable predictions can take significant time as well as a large number of resources and/or expensive resources (e.g., computing cycles of graphics processing units (GPUs), inference processing units (IPUs), etc.). With the set of deterministic rules 126, particular rules can be updated and applied easily over time, e.g., by adding deterministic rules, without updating the machine learning model 122. This allows the machine learning model 122 to be updated less frequently, conserving computing resources for other purposes, which in turn can reduce an amount of power consumed.

Use of the set of deterministic rules 126 also enables rules to be added quickly, such as when rules of an entity (e.g., government entity) are changed (e.g., to add, remove, and/or change tax categories), as new breakthroughs are discovered (e.g., as particular markers for disease or other conditions are identified), and so on. The use of the machine learning override system 106 thus provides a flexibility and a timely adaptability that is not possible through use of the machine learning model 122 alone.

Having considered an example of an environment, consider now a discussion of some example details of the techniques for rules based override of machine learning output in accordance with one or more implementations.

### Rules Based Override of Machine Learning Output

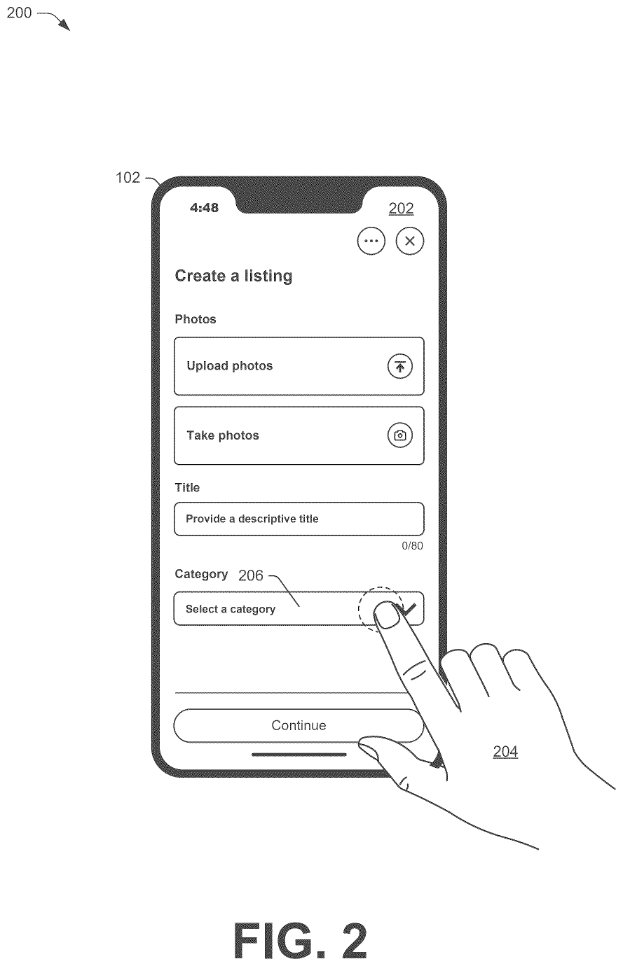

FIG. 2 depicts an example 200 of a user interface displayed in a scenario where rules based override of machine learning output is utilized.

The illustrated example 200 includes the computing device 102 displaying a listing creation user interface 202. The listing creation user interface 202 includes a variety of interactive user interface elements with which a user 204 can interact to provide information about an item that the user 204 would like to list on the online marketplace 112. As noted above, the online marketplace 112 receives input via such interactive elements to specify various information for a listing and populates one or more attributes of the listing based on the information received.

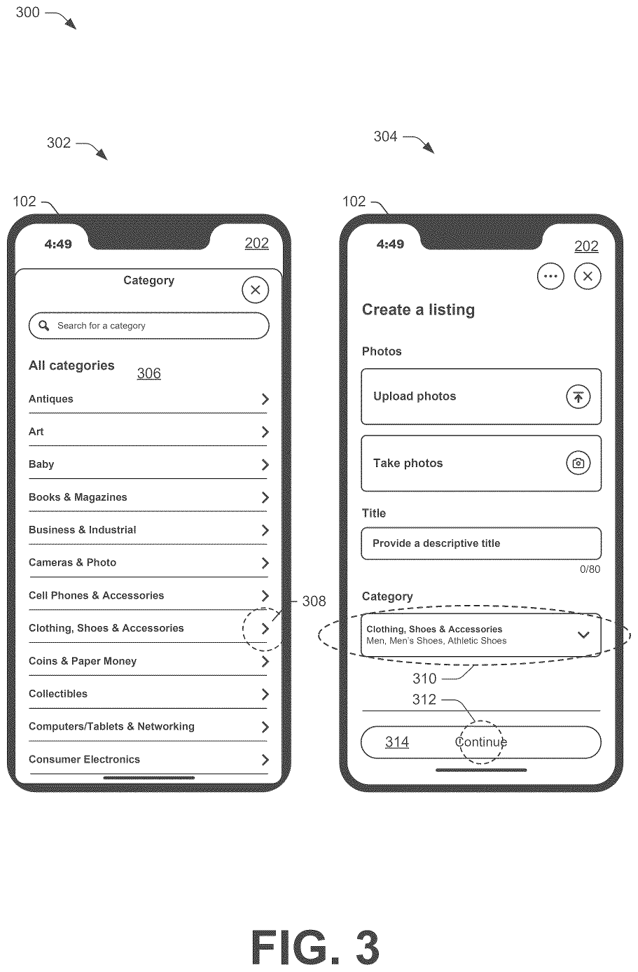

In this particular example 200, the user 204 is depicted interacting with a category instrumentality 206, which enables the user 204 to select a category for the listing being created. For example, selection of the category instrumentality 206 initiates display of further information and/or interactive elements for selecting a category for the listing. In this context, consider the following discussion of FIG. 3.

FIG. 3 depicts another example 300 of a user interface displayed in a scenario where rules based override of machine learning output is utilized.

The illustrated example 300 depicts the computing device 102 displaying the listing creation user interface 202 at a first stage 302 and a second stage 304. In the first stage 302, the listing creation user interface 202 presents a selectable listing of categories 306, which include instrumentalities to drill down further into a respective category or to select the category to be applied to the listing. The listing creation user interface 202 may present the selectable listing of categories 306 responsive to selection by the user 204 of the category instrumentality 206. In the illustrated example, input indicator 308 is shown to indicate a category instrumentality from the selectable listing of categories 306 relative to which user input is received in association with the continuing example.

In the second stage 304, the listing creation user interface 202 is shown with a category having been selected, namely, a category of ‘Clothing, Shoes & Accessories—Men, Men's Shoes, Athletic Shoes’. In at least one implementation, this corresponds to a user input or user selected category 310. A user selected category 310 may be adapted as an attribute 120 of the listing 118. Further, in one or more implementations, the user selected category 310 may be provided as input to the machine learning model 122 (e.g., for predicting the machine learning model 122) and/or the machine learning override system 106 (e.g., for selecting which rules to apply and/or as information relative to which the selected rule(s) 136 are applied). The user selected category 310 may be provided with other information (e.g., attribute(s) 120) of the listing 118 as such input.

The illustrated example 300 also includes an additional input indicator 312 shown in relation to a confirmation user interface element 314 (e.g., a continue button). In one or more implementations, selection of the confirmation user interface element 314 causes the user selected category 310 to be submitted to the online marketplace 112 for processing, such as to include the user selected category 310 as part of the listing 118 and/or to initiate the process of predicting a category for the listing using the machine learning model 122 and confirming or overriding the predicted category using the machine learning override system 106. Thus, in one or more implementations, user selection of the confirmation user interface element 314 causes the online marketplace 112 to provide information about the listing 118 (e.g., the attribute(s) 120) to the machine learning model 122. The online marketplace 112 also provides information about the listing 118 (e.g., the attribute(s) 120) to the machine learning override system 106, and the category 124 predicted by the machine learning model 122 is also provided to the machine learning override system 106.

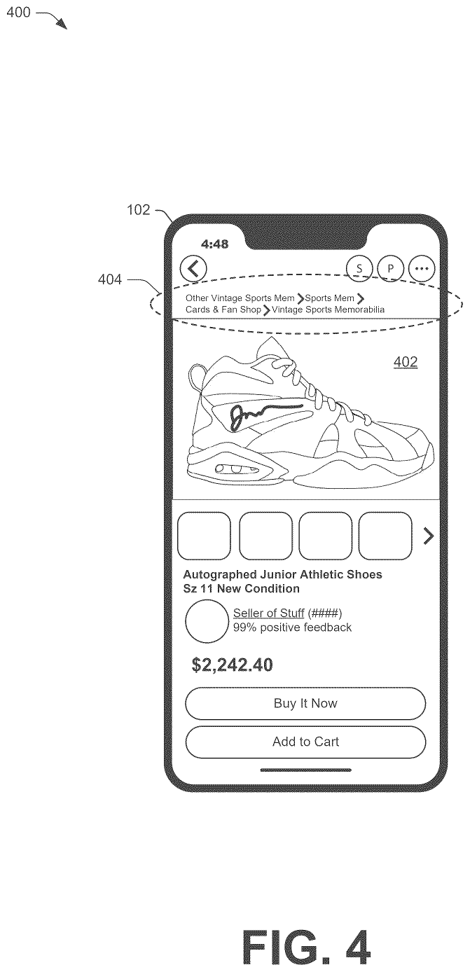

The machine learning override system 106 may override a user selected category and/or the category 124 predicted by the machine learning model 122 by applying selected rules to the input information. In at least one implementation, the machine learning override system 106 outputs the different category 138 for the listing 118, which overrides or replaces the user selected category and/or the category 124 predicted by the machine learning model 122. In this context, consider FIG. 4.

FIG. 4 depicts another example 400 of a user interface displayed in a scenario where rules based override of machine learning output is utilized.

The illustrated example 400 includes the computing device 102 displaying a view item user interface 402. The view item user interface 402 presents a variety of information published by the online marketplace 112 in connection with the listing, such as a title, images, price, seller information, and user interface elements to add the listed item to an online shopping cart or to buy it now. In addition to this information, the view item user interface 402 includes a category for the listing 118.

Relative to the category depicted at the second stage 304 of FIG. 3 (e.g., the user selected category 310) the category 404 displayed as part of the view item user interface 402 for the listing 118 is different, e.g., ‘Clothing, Shoes & Accessories—Men, Men's Shoes, Athletic Shoes’ versus ‘Other Vintage Sports Memorabilia—Sports Memorabilia, Cards & Fan Shop, Vintage Sports Memorabilia’. This may be the case, for instance, where the machine learning override system 106 processed the input information and overrode the category selected by the user and/or the category 124 predicted for the listing 118 by the machine learning model 122. In this particular example, for instance, tax codes in various jurisdictions may tax sports memorabilia differently than athletic shoes, even when the sports memorabilia in question comprises athletic shoes. The presence of information in the listing 118, e.g., some indication of an autograph, for instance, may have been criteria for selecting particular rules from the set of deterministic rules 126 and/or an if-condition of a selected rule applicable to identify the different category 138 for the category.

Having discussed exemplary details of rules-based override of machine learning output, consider now some examples of procedures to illustrate additional aspects of the techniques.

### Example Procedures

This section describes examples of procedures for rules-based override of machine learning output. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

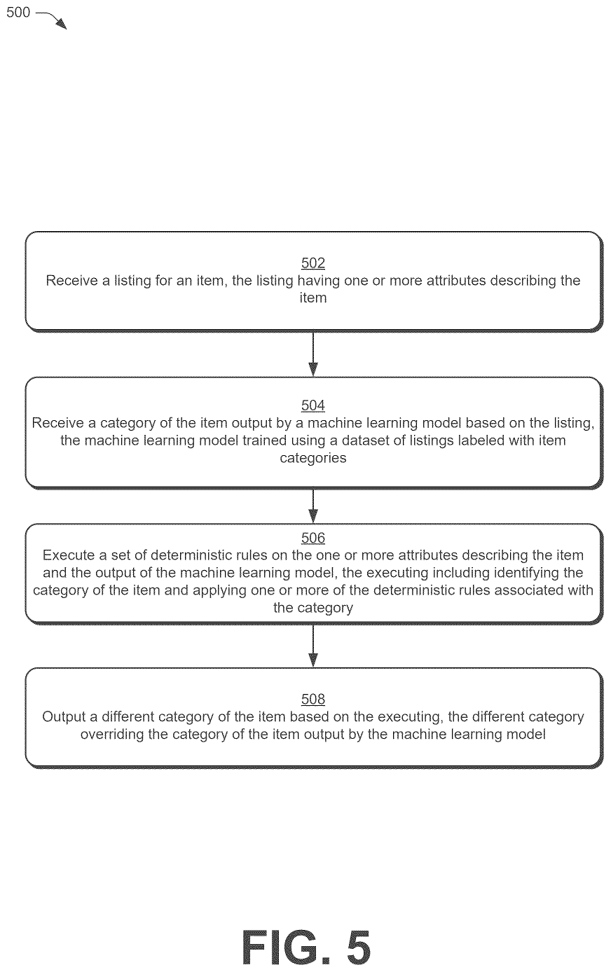

FIG. 5 depicts a procedure 500 in an example implementation of rules based override of machine learning output.

A listing for an item is received that has one or more attributes describing the item (block 502). By way of example, the machine learning override system 106 receives the listing 118, which includes one or more of the attribute(s) 120 which describe an item listed by the listing 118.

A category of the item is received that has been output by a machine learning model based on the listing (block 504). In accordance with the principles discussed herein, the machine learning model has been trained using a dataset of listings labeled with item categories. By way of example, the machine learning override system 106 receives the category 124 output by the machine learning model 122 based on the listing 118, which may include one or more of the attribute(s) 120 of the listing 118. In accordance with the described techniques, the machine learning model 122 is trained with a dataset 128 of the listings 118, e.g., from the real-time listing data 116 of the online marketplace 112. As noted above, the online marketplace 112 may be trained or retrained periodically, e.g., at some regular or irregular interval in terms of timing and/or in terms of amount of rule changes, with a dataset 128 from the real-time listing data 116.

A set of deterministic rules is executed on the one or more attributes describing the item and the output of the machine learning model (block 506). In accordance with the principles described herein, the executing includes identifying the category of the item and applying one or more of the deterministic rules associated with the category. By way of example, the set of deterministic rules 126 is executed on the attribute(s) 120 of the listing 118. In one or more implementations, this includes identifying a category of the listing 118 and associating or otherwise selecting one or more rules of the set of deterministic rules 126 for application to the listing 118 and/or its category. The executing also includes applying the selected rule(s) 136 associated with the category. By applying only the selected rule(s) 136 and not all of the set of deterministic rules 126, the machine learning override system 106 may reduce an amount of computing resources utilized (e.g., computing cycles utilized to execute instructions) relative to applying all of the rules.

A different category of the item is output based on the executing (block 508). In accordance with the principles discussed herein, the different category overrides the category of the item output by the machine learning model. By way of example, the machine learning override system 106 outputs the different category 138, which overrides (e.g., is different from) the category 124 output by the machine learning model 122.

In at least one scenario, the different category 138 is provided to the computing device 102, such as for display in the view item user interface 402, e.g., instead of the category 124. Alternatively or additionally, the different category 138 is output and is used for one or more different purposes, such as for an amount of tax to apply to a purchase of the item listed by the listing 118, e.g., because items in different categories can have different amount of taxes applied. For example, there may be a different amount of tax applied to a toy mattress (e.g., associated with a ‘toy’ category) than to an actual mattress (e.g., associated with a ‘mattress for sleeping’ or ‘furniture’ category). Thus, overriding a listing's category for an actual mattress with the ‘toy’ category, has tax implications.

Having described examples of procedures in accordance with one or more implementations, consider now an example of a system and device that can be utilized to implement the various techniques described herein.

### Example System and Device

FIG. 6 illustrates an example of a system generally at 600 that includes an example of a computing device 602 that is representative of one or more computing systems and/or devices that may implement the various techniques described herein. This is illustrated through inclusion of the application 110 and the machine learning override system 106. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random-access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

In some aspects, the techniques described herein relate to a computer-implemented method including: receiving, by one or more processors, a listing for an item, the listing having one or more attributes describing the item; receiving, by the one or more processors, a category of the item as output by a machine learning model based on the listing, the machine learning model trained using a dataset of listings labeled with item categories; executing, by the one or more processors, a set of deterministic rules on the one or more attributes describing the item and the output of the machine learning model, the executing including identifying the category of the item and applying one or more of the deterministic rules associated with the category; and outputting, by the one or more processors, a different category of the item based on the executing, the different category overriding the category of the item as output by the machine learning model.

In some aspects, the techniques described herein relate to a computer-implemented method, wherein in the category is associated with a first tax code, and the different category is associated with a second tax code.

In some aspects, the techniques described herein relate to a computer-implemented method, wherein the dataset of listings that is used to train the machine learning model does not include listings labeled with the different category.

In some aspects, the techniques described herein relate to a computer-implemented method, wherein the set of deterministic rules is modifiable by user input without retraining the machine learning model.

In some aspects, the techniques described herein relate to a computer-implemented method, wherein the set of deterministic rules is further executed based on a category selected by a user associated with the listing.

In some aspects, the techniques described herein relate to a computer-implemented method, wherein executing the set of deterministic rules includes: selecting a subset of rules from the set of deterministic rules based on the category output by the machine learning model; and applying the subset of rules to the one or more attributes describing the item.

In some aspects, the techniques described herein relate to a computer-implemented method, wherein selecting the subset of rules is further based on a confidence score output by the machine learning model in connection with the category.

In some aspects, the techniques described herein relate to a computer-implemented method, wherein executing the set of deterministic rules is based on the confidence score failing to satisfy a threshold confidence.

In some aspects, the techniques described herein relate to a computer-implemented method, further including: obtaining a probability associated with the output of the machine learning model; and executing the set of deterministic rules based on the probability failing to satisfy a threshold value.

In some aspects, the techniques described herein relate to a computer-implemented method, wherein the probability is output by the machine learning model.

In some aspects, the techniques described herein relate to a system including: one or more processors; and memory storing instructions that, when executed by the one or more processors, cause the system to: receive a listing for an item, the listing having one or more attributes describing the item; obtain a category of the item as output by a machine learning model based on the listing, the machine learning model trained using a dataset of listings labeled with item categories; execute a set of deterministic rules on the one or more attributes describing the item and on the output of the machine learning model, the executing including identifying the category of the item and applying one or more of the deterministic rules associated with the category; and output a different category of the item based on the executing, the different category overriding the category of the item as output by the machine learning model.

In some aspects, the techniques described herein relate to a system, wherein the category is associated with a first tax code, and the different category is associated with a second tax code.

In some aspects, the techniques described herein relate to a system, wherein the dataset of listings that is used to train the machine learning model does not include listings labeled with the different category.

In some aspects, the techniques described herein relate to a system, wherein the set of deterministic rules is applicable during the executing without retraining the machine learning model.

In some aspects, the techniques described herein relate to a system, wherein executing the set of deterministic rules includes: selecting a subset of rules from the set of deterministic rules based on the category output by the machine learning model; and applying the subset of rules to the one or more attributes describing the item.

In some aspects, the techniques described herein relate to a system, wherein selecting the subset of rules is further based on a confidence score output by the machine learning model in connection with the category.

In some aspects, the techniques described herein relate to a system, wherein the instructions further cause the system to display the different category in a view of the listing published by an online marketplace.

In some aspects, the techniques described herein relate to a system, wherein the instructions, when executed by the one or more processors, further cause the system to: obtain a probability associated with the output of the machine learning model; and execute the set of deterministic rules based on the probability failing to satisfy a threshold value.

In some aspects, the techniques described herein relate to a system, wherein the probability is output by the machine learning model.

In some aspects, the techniques described herein relate to a non-transitory computer-readable storage medium storing instructions that, when executed by one or more processors, cause the one or more processors to perform operations including: receiving a listing for an item, the listing having one or more attributes describing the item; obtaining a category of the item as output by a machine learning model based on the listing, the machine learning model trained using a dataset of listings labeled with item categories; executing a set of deterministic rules on the one or more attributes describing the item and the output of the machine learning model, the executing including identifying the category of the item and applying one or more of the deterministic rules associated with the category; and outputting a different category of the item based on the executing, the different category overriding the category of the item as output by the machine learning model.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, by one or more processors, a listing for an item, the listing having one or more attributes describing the item;
receiving, by the one or more processors, a category of the item as output by a machine learning model based on the listing, the machine learning model trained using a dataset of listings labeled with item categories;
executing, by the one or more processors, a set of deterministic rules on the one or more attributes describing the item and the output of the machine learning model, the executing including identifying the category of the item and applying one or more of the deterministic rules associated with the category; and
outputting, by the one or more processors, a different category of the item based on the executing, the different category overriding the category of the item as output by the machine learning model.

2. The computer-implemented method of claim 1, wherein in the category is associated with a first tax code, and the different category is associated with a second tax code.

3. The computer-implemented method of claim 1, wherein the dataset of listings that is used to train the machine learning model does not include listings labeled with the different category.

4. The computer-implemented method of claim 1, wherein the set of deterministic rules is modifiable by user input without retraining the machine learning model.

5. The computer-implemented method of claim 1, wherein the set of deterministic rules is further executed based on a category selected by a user associated with the listing.

6. The computer-implemented method of claim 1, wherein executing the set of deterministic rules comprises:
selecting a subset of rules from the set of deterministic rules based on the category output by the machine learning model; and
applying the subset of rules to the one or more attributes describing the item.

7. The computer-implemented method of claim 6, wherein selecting the subset of rules is further based on a confidence score output by the machine learning model in connection with the category.

8. The computer-implemented method of claim 7, wherein executing the set of deterministic rules is based on the confidence score failing to satisfy a threshold confidence.

9. The computer-implemented method of claim 1, further comprising:
obtaining a probability associated with the output of the machine learning model; and
executing the set of deterministic rules based on the probability failing to satisfy a threshold value.

10. The computer-implemented method of claim 9, wherein the probability is output by the machine learning model.

11. A system comprising:
one or more processors; and
memory storing instructions that, when executed by the one or more processors, cause the system to:
receive a listing for an item, the listing having one or more attributes describing the item;
obtain a category of the item as output by a machine learning model based on the listing, the machine learning model trained using a dataset of listings labeled with item categories;
execute a set of deterministic rules on the one or more attributes describing the item and on the output of the machine learning model, the executing including identifying the category of the item and applying one or more of the deterministic rules associated with the category; and
output a different category of the item based on the executing, the different category overriding the category of the item as output by the machine learning model.

12. The system of claim 11, wherein the category is associated with a first tax code, and the different category is associated with a second tax code.

13. The system of claim 11, wherein the dataset of listings that is used to train the machine learning model does not include listings labeled with the different category.

14. The system of claim 11, wherein the set of deterministic rules is applicable during the executing without retraining the machine learning model.

15. The system of claim 11, wherein executing the set of deterministic rules comprises:
selecting a subset of rules from the set of deterministic rules based on the category output by the machine learning model; and
applying the subset of rules to the one or more attributes describing the item.

16. The system of claim 15, wherein selecting the subset of rules is further based on a confidence score output by the machine learning model in connection with the category.

17. The system of claim 11, wherein the instructions further cause the system to display the different category in a view of the listing published by an online marketplace.

18. The system of claim 11, wherein the instructions, when executed by the one or more processors, further cause the system to:
obtain a probability associated with the output of the machine learning model; and
execute the set of deterministic rules based on the probability failing to satisfy a threshold value.

19. The system of claim 18, wherein the probability is output by the machine learning model.

20. A non-transitory computer-readable storage medium storing instructions that, when executed by one or more processors, cause the one or more processors to perform operations comprising:
receiving a listing for an item, the listing having one or more attributes describing the item;
obtaining a category of the item as output by a machine learning model based on the listing, the machine learning model trained using a dataset of listings labeled with item categories;
executing a set of deterministic rules on the one or more attributes describing the item and the output of the machine learning model, the executing including identifying the category of the item and applying one or more of the deterministic rules associated with the category; and
outputting a different category of the item based on the executing, the different category overriding the category of the item as output by the machine learning model.
